(19) United States
(12) Patent Application Publication
(10) Pub. No.: US 2019/0248088 A1
(43) Pub. Date: Aug. 15, 2019

(54) SECONDARY MOULDING PROCESS FOR PREPARING HIGH RESILIENCE MATERIALS USING E-TPU PARTICLES

(71) Applicant: Junfeng Lin, Neijiang (CN)

(72) Inventor: Junfeng Lin, Neijiang (CN)

(21) Appl. No.: 16/202,128

(22) Filed: Nov. 28, 2018

(30) Foreign Application Priority Data
Feb. 9, 2018 (CN) 201810136645.6

(51) Int. Cl. B29D 35/00; B29D 35/14; B29C 43/52; A43B 13/04; A43B 13/18

(52) U.S. Cl. CPC B29D 35/0054; B29D 35/142; B29K 2075/00; A43B 13/04; A43B 13/187; B29C 43/52

(57) ABSTRACT

The present invention belongs to the technical field of polyurethane elastomer application, and discloses a secondary moulding process for preparing high resilience materials using E-TPU particles. An E-TPU rough blank is prepared by using E-TPU particles through a steam compression moulding process, and then a position for an accessory is reserved on the E-TPU rough blank; the E-TPU rough blank pretreated by the adhesive and the accessory are put correspondingly into the mould, the steam or electrothermal compression moulding process is performed, and then a cooling shaping process is performed to obtain the finished product; and the finished product is trimmed, arranged and packaged. The process flow of the present invention greatly improves the appearance, reduces subsequent labor costs, and improves limitations to the design space of the product diversity (including complexity of the pattern and various accessory combinations, etc.).

### CROSS REFERENCE TO RELATED APPLICATIONS

This application is based upon and claims priority to Chinese Patent Application No. 201810136645.6, filed on Feb. 9, 2018, the entire contents of which are incorporated herein by reference.

### TECHNICAL FIELD

The present invention belongs to the technical field of polyurethane elastomer application, and specifically relates to a secondary moulding process for preparing high resilience materials using E-TPU particles.

### BACKGROUND

Expanded thermoplastic polyurethane (E-TPU) is becoming increasingly popular as one of the raw materials for shoemaking in recent years. E-TPU is a polymer foam material, the product thereof has an elliptical or nearly circular shape and a diameter of 5-7 mm, which is known as E-TPU popcorn in the shoemaking industry. The product is exclusively created by BASF Germany in the world. In recent years, many factories in China have successfully developed and achieved mass production. Different shapes of products may be prepared by pumping the E-TPU particles into a mould by an EPP moulding machine and then pumping steam into the mould for heating and pressurization.

E-TPU is widely used in the products such as child-specific protective floor, plastic track, running shoes, safety pillows, lightweight tires, etc., because it has the advantages of environmental protection, high resilience, comfort, etc.

However, products moulded by E-TPU have some shortcomings due to its manufacturing process. Take the shoe sole as an example for explanation. First, the edge that fits the vamp needs to be wide enough (the width is greater than 4 mm, as shown in FIG. 1), which affects product design and shoe aesthetics. The reason is that the average diameter of the raw material particles is about 6 mm, if the width (i.e., the gap of the mould for manufacturing the shoe sole) is insufficient, the raw material particles cannot fill all the space, such as the small edges shown in FIG. 2. Moreover, this reason also greatly limits the design range, small patterns and shapes may not be designed, which greatly limits the design space of the products.

Second, plenty of bulge traces of pores exist in the appearance of the shoe sole, which affects the looks of the products.

Third, since the abrasion resistance of the E-TPU finished product is not good enough, the bottom of the product needs to be brushed with the glue and then attached with the outsole, such as a rubber shoe sole, through a manual method or a mechanical method. Manufacturing processes and labor costs may be increased. Moreover, only a single finished product may be manufactured, other accessories and decorative parts have to be attached thereon in the subsequent process, which increases the process and cost.

Fourth, the product may be made into only one color, namely white, which limits the color matching of the finished shoes, that is, the color is simple and monotonous. In order to make the finished shoes colorful, a subsequent manual processing is needed, such as brushing the glue on the finished shoes and then attaching other accessories thereon, resulting in additional processing and costs.

### SUMMARY

In order to solve the above problems in the prior art, the objective of the present invention is to provide a secondary moulding process for preparing high resilience materials using E-TPU particles. The finished product, such as the upper edge of the insole, may be made into a beautiful, small arc according to different designs, which broadens the design range of the product. It is also possible to add accessories such as a non-slip rubber shoe sole as needed, or add some decorative accessories to make the finished product more beautiful, and the surface of the finished product has no bulge traces caused by the pores.

The technical solution of the present invention is as follows.

A secondary moulding process for preparing high resilience materials using E-TPU particles includes the following steps:

step 1: preparing an E-TPU rough blank by using E-TPU particles through a steam compression moulding process, and reserving a position for an accessory on the E-TPU rough blank;

step 2: gluing pretreatment: attaching an adhesive to the position for the accessory on the E-TPU rough blank described in the step 1, and correspondingly, also attaching the adhesive to the accessory;

step 3: making a mould according to a design pattern of a final finished product: engraving or casting a mould corresponding to the design pattern on a rigid plate;

step 4: putting the E-TPU rough blank pretreated by the adhesive and the accessory in the step 2 into the mould in the above step 3 correspondingly, performing the steam or electrothermal compression moulding process and then performing a cooling shaping process to obtain the finished product;

step 5: taking out the finished product in the above step 4, trimming, arranging and packaging the finished product.

Further, the accessory in the above step 1 includes an abrasion resistant rubber outsole, a decorative part or a combination thereof.

Further, the number of the E-TPU rough blank in the above step 1 is one or more.

Further, a heating temperature of the mould in the steam compression moulding process in the above step 4 is 150° C.-170° C.

Further, a clamping pressure of the mould in the steam compression moulding process in the above step 4 is 80 kgf.

Further, a time of the mould clamping and hot pressing in the steam compression moulding process in the above step 4 is 400 s-500 s.

Further, a cooling time of the mould in the steam compression moulding process in the above step 4 is 400 s-500 s.

The beneficial effects of the present invention are as follows.

The process flow of the present invention has a substantial improvement on the appearance and subsequent labor costs; the limitations to design space of the product diversity have been greatly improved (including complexity of patterns and various accessory combinations, etc.). Specific advantages are as below:

1. The upper edge of the shoe sole may be made into beautiful, small arc and thickness (such as a small design of less than 4 mm in thickness) according to different designs, and small patterns and details may be created, thus extending the design range.

2. The pores and air intake traces on the E-TPU rough blank are completely eliminated by the second moulding process of the present invention, so that the appearance of the shoe sole and the finished shoe are greatly improved.

3. The E-TPU rough blank may be moulded with other shoe materials at one time, for example, abrasion resistant rubber outsole is pre-attached to the corresponding position at the bottom of the E-TPU rough blank for secondary moulding, thus saving the subsequent work of brushing the glue and then attach the outsole thereon manually or mechanically, which greatly saves the process and cost.

4. By using the process of the present invention, the position for other shoe materials may be reserved on the E-TPU rough blank, so that the process of the present invention may achieve combined moulding with other shoe materials, which greatly extending the design range.

5. After the process flow of the present invention, the concave arc around the original particles becomes a convex, which becomes a feature of the process flow of the present invention.

### BRIEF DESCRIPTION OF THE DRAWINGS

FIG. 1 is a schematic diagram of E-TPU particles filling in a mould.

FIG. 2 is a schematic diagram showing E-TPU particles incapable of filling a small space in a mould.

FIG. 3 is a structural schematic diagram of an upper mould and a lower mould of a mould of a secondary moulding process for preparing high resilience materials using E-TPU particles of the present invention.

FIG. 4 is a structural schematic diagram of an E-TPU rough blank and an accessory of a secondary moulding process for preparing high resilience materials using E-TPU particles of the present invention.

FIG. 5 is a structural schematic diagram showing a mould clamping of an upper mould and a lower mould of a secondary moulding process for preparing high resilience materials using E-TPU particles of the present invention.

FIG. 6 is a cross-sectional comparative diagram of a rough blank and a finished product of a secondary moulding process for preparing high resilience materials using E-TPU particles of the present invention.

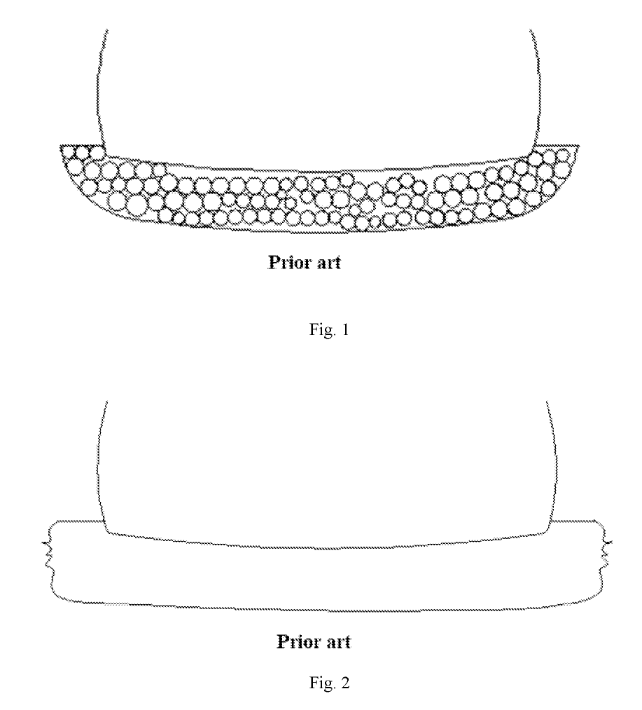

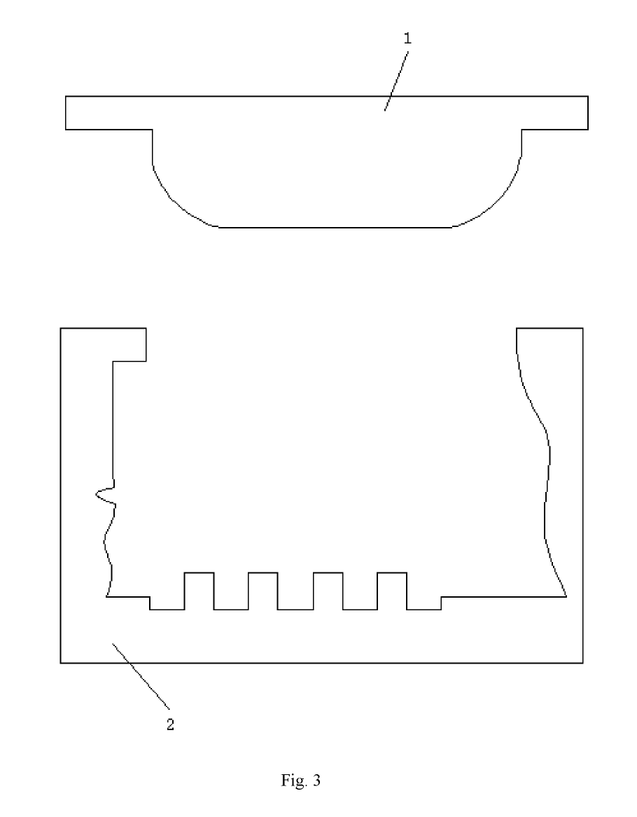

In the drawings, 1—upper mould; 2—lower mould; 3—E-TPU rough blank; 4—abrasion resistant rubber outsole; 5-second accessory; and 6-third accessory.

### DETAILED DESCRIPTION OF THE EMBODIMENTS

The present invention will be further described below in conjunction with the accompanying drawings and specific embodiments.

### Embodiment 1

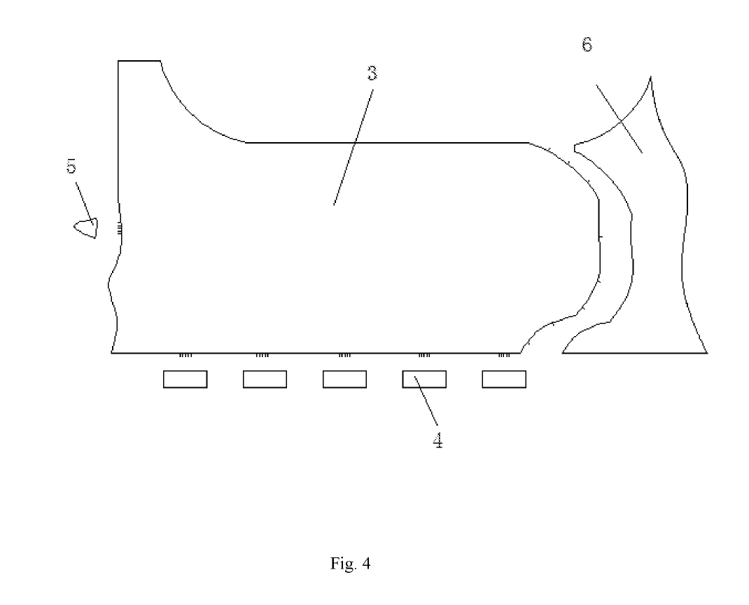

Referring to FIGS. 3-5, the present embodiment provides a secondary moulding process for preparing high resilience materials using E-TPU particles, including the following steps:

step 1: an E-TPU rough blank 3 is prepared by using E-TPU particles through a steam compression moulding process, wherein the original design detail may be ignored at a position where the detailed pattern is required, so that the mould may be filled with the raw material particles; a position where the decorative part or detailed pattern is subsequently added, namely, a position for an accessory on the E-TPU rough blank 3, is reserved; specifically, the accessory includes an abrasion resistant rubber outsole 4, a decorative part or a combination thereof.

The original design detail may be ignored means that, for example, the width and depth of the design pattern of some shoe soles are 1 mm and 2 mm, respectively, and the existing moulding process using E-TPU cannot make such a small pattern, then, in the present invention, this kind of design details at this stage may be ignored, only the broad outline is needed, the specific details are left to the secondary shaping flow stage, and the details may be fully realized according to the design requirements in the subsequent mould design.

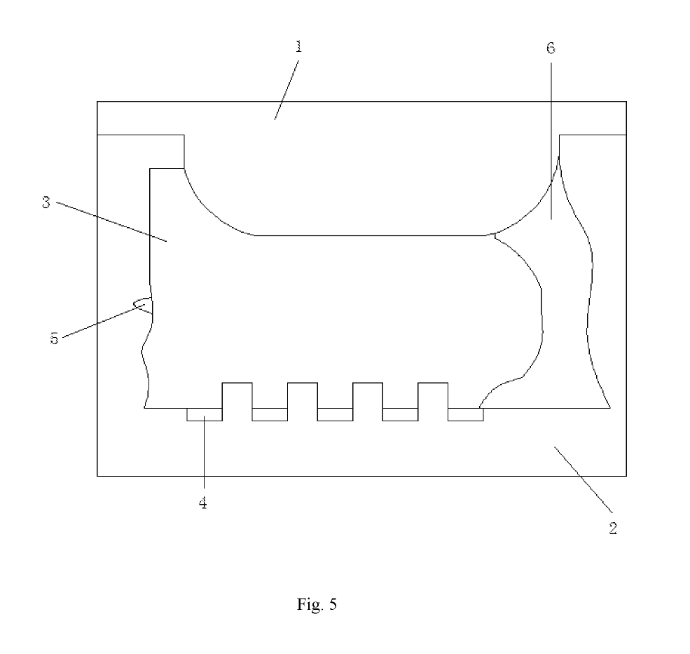

step 2: an adhesive is attached to the position for the accessory on the E-TPU rough blank 3 described in the step 1, and correspondingly, the adhesive is also attached to the accessory, wherein other accessories such as abrasion resistant rubber outsole 4 and decorative accessory (such as the second accessory 5 and the third accessory 6 in FIG. 4) may be prepared in advance, and a gluing pretreatment is performed on the adhesive surfaces of the E-TPU rough blank 3 and the accessory for attaching.

step 3: a mould is made according to a design pattern of a final finished product: a mould corresponding to the design pattern is engraved or casted on a rigid plate, wherein mould design and preparation may be carried out according to all the details of the shoe sole design, and the upper mould and lower mould may be made according to the design pattern of the final finished product, specifically, the upper mould and lower mould having the pattern are engraved or casted on the rigid plate. The space reserved by the lower mould in FIG. 3 is designed and reserved according to the design of the shoe sole of the final designed finished product. According to the different designs of the finished shoe sole, if some mould structure needs a middle frame, the upper mould, the middle frame and the lower mould may be made according to the design pattern of the final finished product: the upper mould, the middle frame and the lower mould having the pattern are engraved or casted on the rigid plate. If some mould structure does not need a middle frame, as shown in FIG. 3 of the present embodiment without a middle frame, the mould structure (i.e., the mould without a middle frame) does not affect the process flow of the present invention, it will not be described here.

step 4: the E-TPU rough blank 3 pretreated by the adhesive and the accessory in the step 2 are put into the lower mould 2 of the mould in the above step 3 accordingly, the steam or electrothermal compression moulding process is performed, and then a cooling shaping process is performed to obtain the finished product, wherein the E-TPU rough blank 3 placed in the lower mould 2 of the mould may be of one or more types.

Specifically, the heating temperature of the mould in the steam compression moulding process is 150° C., and the time of the mould clamping and hot pressing thereof is 400 s-500 s; the cooling time of the mould in the steam compression moulding process is 400 s-500 s; the clamping pressure of the mould in the steam compression moulding process is 80 kgf. The heating and cooling time may be adjusted according to the thickness of the material (such as the thickness of the designed shoe sole).

step 5: the finished product in the above step 4 is taken out, and then the finished product is trimmed, arranged and packaged.

### Embodiment 2

Referring to FIGS. 3-5, the present embodiment provides a secondary moulding process for preparing high resilience materials using E-TPU particles, including the following steps:

step 1: an E-TPU rough blank 3 is prepared by using E-TPU particles through a steam compression moulding process, wherein the original design detail may be ignored at a position where the detailed pattern is required, so that the mould may be filled with raw material particles; a position where the decorative part or detailed pattern is subsequently added, namely, a position for an accessory on the E-TPU rough blank 3, is reserved; specifically, the accessory includes an abrasion resistant rubber outsole 4, a decorative part or a combination thereof.

The original design detail may be ignored means that, for example, the width and depth of the design pattern of some shoe soles are 1 mm and 2 mm, respectively, and the existing moulding process using E-TPU cannot make such a small pattern, then, in the present invention, this kind of design details at this stage may be ignored, only the broad outline is needed, the specific details are left to the secondary shaping flow stage, and the details may be fully realized according to the design requirements in the subsequent mould design.

step 2: an adhesive is attached to the position for the accessory on the E-TPU rough blank 3 described in the step 1, and correspondingly, the adhesive is also attached to the accessory, wherein other accessories such as abrasion resistant rubber outsole 4 and decorative accessory (such as the second accessory 5 and the third accessory 6 in FIG. 4) may be prepared in advance, and a gluing pretreatment is performed on the adhesive surfaces of the E-TPU rough blank 3 and the accessory for attaching.

step 3: a mould is made according to a design pattern of a final finished product: a mould corresponding to the design pattern is engraved casted on a rigid plate, wherein mould design and preparation may be carried out according to all the details of the shoe sole design, and the upper mould and lower mould may be made according to the design pattern of the final finished product, specifically, the upper mould and lower mould having the pattern are engraved or casted on the rigid plate. The space reserved by the lower mould in FIG. 3 is designed and reserved according to the design of the shoe sole of the final designed finished product. According to the different designs of the finished shoe sole, if some mould structure needs a middle frame, the upper mould, the middle frame and the lower mould may be made according to the design pattern of the final finished product: the upper mould, the middle frame and the lower mould having the pattern are engraved or casted on the rigid plate. If some mould structure does not need a middle frame, as shown in FIG. 3 of the present embodiment without a middle frame, the mould structure (i.e., the mould without a middle frame) does not affect the process flow of the present invention, it will not be described here.

step 4: the E-TPU rough blank 3 pretreated by the adhesive and the accessory in the step 2 are put into the lower mould 2 of the mould in the above step 3 correspondingly, the steam or electrothermal compression moulding process is performed, and then a cooling shaping process is performed to obtain the finished product, wherein the E-TPU rough blank 3 placed in the lower mould 2 of the mould may be of one or more types.

Specifically, the heating temperature of the mould in the steam compression moulding process is 160° C., and the time of the mould clamping and hot pressing thereof is 400 s-500 s; the cooling time of the mould in the steam compression moulding process is 400 s-500 s; the clamping pressure of the mould in the steam compression moulding process is 80 kgf. The heating and cooling time may be adjusted according to the thickness of the material (such as the thickness of the designed shoe sole).

step 5: the finished product in the above step 4 is taken out, and then the finished product is trimmed, arranged and packaged.

### Embodiment 3

Referring to FIGS. 3-5, the present embodiment provides a secondary moulding process for preparing high resilience materials using E-TPU particles, including the following steps:

step 1: an E-TPU rough blank 3 is prepared by using E-TPU particles through a steam compression moulding process, wherein the original design detail may be ignored at a position where the detailed pattern is required, so that the mould may be filled with raw material particles; a position where the decorative part or detailed pattern is subsequently added, namely, a position for an accessory on the E-TPU rough blank 3, is reserved; specifically, the accessory includes an abrasion resistant rubber outsole 4, a decorative part or a combination thereof.

The original design detail may be ignored means that, for example, the width and depth of the design pattern of some shoe soles are 1 mm and 2 mm, respectively, and the existing moulding process using E-TPU cannot make such a small pattern, then, in the present invention, this kind of design details at this stage may be ignored, only the broad outline is needed, the specific details are left to the secondary shaping flow stage, and the details may be fully realized according to the design requirements in the subsequent mould design.

step 2: an adhesive is attached to the position for the accessory on the E-TPU rough blank 3 described in the step 1, and correspondingly, the adhesive is also attached to the accessory, wherein other accessories such as abrasion resistant rubber outsole 4 and decorative accessory (such as the second accessory 5 and the third accessory 6 in FIG. 4) may be prepared in advance, and a gluing pretreatment is performed on the adhesive surfaces of the E-TPU rough blank 3 and the accessory for attaching.

step 3: a mould is made according to a design pattern of a final finished product: a mould corresponding to the design pattern is engraved or casted on a rigid plate, wherein mould design and preparation may be carried out according to all the details of the shoe sole design, and the upper mould and lower mould may be made according to the design pattern of the final finished product, specifically, the upper mould and lower mould having the pattern are engraved or casted on the rigid plate. The space reserved by the lower mould in FIG. 3 is designed and reserved according to the design of the shoe sole of the final designed finished product. According to the different designs of the finished shoe sole, if some mould structure needs a middle frame, the upper mould, the middle frame and the lower mould may be made according to the design pattern of the final finished product: the upper mould, the middle frame and the lower mould of the pattern are engraved or casted on the rigid plate. If some mould structure does not need a middle frame, as shown in FIG. 3 of the present embodiment without a middle frame, the mould structure (i.e., the mould without a middle frame) does not affect the process flow of the present invention, it will not be described here.

step 4: the E-TPU rough blank 3 pretreated by the adhesive and the accessory in the step 2 are put into the lower mould 2 of the mould in the above step 3 correspondingly, the steam or electrothermal compression moulding process is performed, and then a cooling shaping process is performed to obtain the finished product, wherein the E-TPU rough blank 3 placed in the lower mould 2 of the mould may be of one or more types.

Specifically, the heating temperature of the mould in the steam compression moulding process is 170° C., and the time of the mould clamping and hot pressing thereof is 400 s-500 s; the cooling time of the mould in the steam compression moulding process is 400 s-500 s; the clamping pressure of the mould in the steam compression moulding process is 80 kgf. The heating and cooling time may be adjusted according to the thickness of the material (such as the thickness of the designed shoe sole).

step 5: the finished product in the above step 4 is taken out, and then the finished product is trimmed, arranged and packaged.

In summary, taking the process of preparing a shoe sole according to the present invention as an example, compared with the prior art, the secondary moulding process for preparing high resilience materials using E-TPU particles of the present invention has the following advantages:

1. The upper edge of the shoe sole may be made into beautiful, small arc and thickness (such as a small design of less than 4 mm in thickness) according to different designs, and small patterns and details may be created, thus extending the design range.

2. The pores and air intake traces on the E-TPU rough blank 3 are completely eliminated by the second moulding process of the present invention, so that the appearance of the shoe sole and the finished shoe are greatly improved.

3. The E-TPU rough blank may be moulded with other shoe materials at one time, for example, abrasion resistant rubber outsole is pre-attached to the corresponding position at the bottom of the E-TPU rough blank for secondary moulding, thus saving the subsequent work of brushing the glue and then attach to the outsole thereon manually or mechanically, which greatly saves the processing and cost.

4. By using the process of the present invention, the position for other shoe materials may be reserved on the E-TPU rough blank 3, so that the process of the present invention may achieve a combined moulding with other shoe materials, which greatly extends the design range.

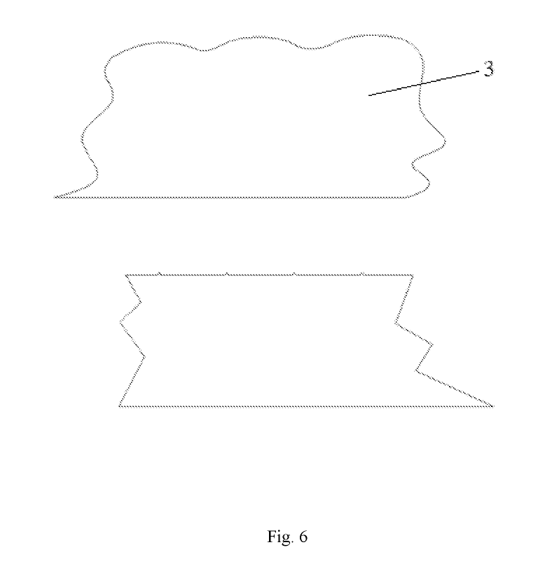

5. As shown in FIG. 6, the upper figure is a cross-sectional diagram of the rough blank, it can be seen that the periphery of the rough blank is in a convex state because of the shape of the E-TPU particles. After the process flow of the present invention (the lower figure of FIG. 6 is a cross-sectional diagram of the moulded finished product), it may be seen that the surface of the particle becomes flat and a periphery thereof is slightly convex.

In summary, through the process flow of the present invention, the appearance is greatly improved, subsequent labor costs are greatly reduced, and the limitations to the design space of the product diversity are greatly improved (including complexity of the pattern and various accessory combinations, etc.).

The present invention is not limited to the above-described optional embodiments, and other products of various forms may be derived by anyone under the inspiration of the present invention. The above-mentioned embodiments should not be construed as limitations to the scope of the present invention. The scope of the present invention should be determined by the claims, and the specification may be used to explain the claims.

What is claimed is:

1. A secondary moulding process for preparing resilience materials using E-TPU particles, comprising the following steps:
step 1), preparing an E-TPU rough blank by using the E-TPU particles through a steam compression moulding process, and reserving a position for an accessory on the E-TPU rough blank;
step 2), gluing pretreatment: attaching an adhesive to the position for the accessory on the E-TPU rough blank described in step 1), and also attaching the adhesive to the accessory corresponding to the position for the accessory on the E-TPU rough blank;
step 3), making a mould according to a design pattern of a final finished product: engraving or casting a mould corresponding to the design pattern on a rigid plate;
step 4), putting the E-TPU rough blank pretreated by the adhesive and the accessory in step 2) correspondingly into the mould in step 3), performing the steam compression moulding process or electrothermal compression moulding process and then performing a cooling shaping process to obtain the final finished product;
step 5), taking out the final finished product in step 4), trimming, arranging and packaging the final finished product.

2. The secondary moulding process for preparing resilience materials using E-TPU particles of claim 1, wherein the accessory in step 1) comprises an abrasion resistant rubber outsole, a decorative part or a combination of the abrasion resistant rubber outsole and the decorative part.

3. The secondary moulding process for preparing resilience materials using E-TPU particles of claim 1, wherein a number of the E-TPU rough blank in step 1) is one or more.

4. The secondary moulding process for preparing high resilience materials using E-TPU particles of claim 3, wherein a heating temperature of the mould in the steam compression moulding process in step 4) is 150° C.-170° C.

5. The secondary moulding process for preparing resilience materials using E-TPU particles of claim 1, wherein a clamping pressure of the mould in the steam compression moulding process in step 4) is 80 kgf.

6. The secondary moulding process for preparing resilience materials using E-TPU particles of claim 5, wherein a time of mould clamping and hot pressing in the steam compression moulding process in step 4) is 400 s-500 s.

7. The secondary moulding process for preparing resilience materials using E-TPU particles of claim 6, wherein a cooling time of the mould in the steam compression moulding process in step 4) is 400 s-500 s.

8. The secondary moulding process for preparing resilience materials using E-TPU particles of claim 2, wherein a number of the E-TPU rough blank in step 1) is one or more.

9. The secondary moulding process for preparing resilience materials using E-TPU particles of claim 8, wherein a heating temperature of the mould in the steam compression moulding process in step 4) is 150° C.-170° C.

10. The secondary moulding process for preparing resilience materials using E-TPU particles of claim 2, wherein a clamping pressure of the mould in the steam compression moulding process in step 4) is 80 kgf.

11. The secondary moulding process for preparing resilience materials using E-TPU particles of claim 4, wherein a clamping pressure of the mould in the steam compression moulding process in step 4) is 80 kgf.

12. The secondary moulding process for preparing resilience materials using E-TPU particles of claim 9, wherein a clamping pressure of the mould in the steam compression moulding process in step 4) is 80 kgf.
